(19) United States
(12) Patent Application Publication
(10) Pub. No.: US 2003/0220830 A1
(43) Pub. Date: Nov. 27, 2003

(54) Method and system for maximizing sales profits by automatic display promotion optimization

(76) Inventor: David Myr, Jerusalem (IL)

Correspondence Address: ELMAN TECHNOLOGY LAW, P.C., P O BOX 209, SWARTHMORE, PA, 19081-0209, US

(21) Appl. No.: 10/115,698

(22) Filed: Apr. 4, 2002

(51) Int. Cl. G06F 17/60

(52) U.S. Cl. 705/10; 705/14

(57) ABSTRACT

The present invention is remotely controlled automatic optimization system for maximizing in-store net profits by customized script-generated clip promotions to thousands of individually networked retail display-nodes from central server (OptiRetailChain). The computer-based and machine-learning display system includes: an advertising optimization function for display nodes, point of sale (POS) data input, retail database mining engine (RDME), client access and management control module, and in-store networked electronic clip display apparatus. The optimization function obtains data from chain-store database, combines product bundling data, which describe the associative relationships of various product sales in stores with recorded times of sale, inventory costs, margin profits etc. Physical location of purchased products on the store floor-areas are correlated with relevant display-nodes to create optimal clip display program (playlist) configurations for that specific display location and time. Most preferred product advertising combinations will be displayed in the best time slots for each node automatically. OptiRetailChain uses two methods of promotion optimization: real time scheduling and longer-term statistical optimization. Utilizing the machine learning capabilities, actual video-clip playlists will be dynamically updated for every display-node and respond to daily sales fluctuations for that store display location. This enables the optimization system to effectively control and automatically feature target advertising to large number of display-nodes in supermarket chain networks optimizing advertising capital without necessitating outside intervention.

### PRIOR ART

Point of purchase (POP) advertising is today a major marketing tool in retail environment. When considering that more than 70% of all retail sales are unplanned by consumers when they enter retail area (impulse buying) one will immediately appreciate the crucial role a well optimized POP advertising campaign will have on global purchasing and revenues.

POP in-store advertising has undergone a radical change in the last few years.

With the advent of World Wide Web, virtual supermarkets and virtual web enabled electronic advertising, it has become imperative to introduce digital advertising in retail environment for product promotions. Many of the Web enabled systems use data mining capabilities to further improve in-store revenues.

Several POP advertising systems have also been proposed for remote electronic display and some for manual updating digital promotion display.

1. I-Open (Axioma): http://www.research.ibm.com/iac/papers/Perine.pdf proposes promotion optimization study using digital signage for Internet enabled in store advertising.

Axioma system consists of promotion optimization, online media planning and dynamic promotion for targeted advertisements. The optimization methodology uses statistical analysis, data analysis and mining, sales and promotion studies and simulation testing. The system utilizes various parameters to evaluate promotion strategy such as increase in sales and customer experience.

Axioma uses optimization to select promotion, to deliver promotion to target by manual input, to find best product mix/product bundling, best site(s) to run promotion, best time of day to run promotion and other functions such as graphic display, discounts etc.

This system does not show automatic optimization function nor has an automatic data-mining access whereby the promotion system can achieve automatic promotion optimization for a large number of stores or customers. Yet, it is well known that today, in large retail chain environments it is very difficult to manage large-scale promotion system manually or on individual per-store basis. Furthermore the dynamic requirements of the product price fluctuations in retail environment require automatic and dynamic promotion for optimal functioning. For this purpose the present invention introduces machine learning as part and parcel of promotion optimization capabilities.

Scala broadcast multimedia (www.scala.com) utilizes InfoChannel Broadcast Server for multimedia messaging to hundreds and thousands of sites including multiple players to be addressed with a single transmission. Scala supports several network architectures.

including satellite and multicast-IP. While Scala provides content editing and ad managing including retail store advertising this system does not allow at present for automatic advertising optimization and customized display based on basket, content or inventory analysis. Furthermore while the system is dynamic with playback capabilities it is not flexible enough to enable automatic scripting to multitude of individual display nodes and customized script-generated clip display to thousands individual display nodes from a central server in real time.

US 2001/0052000 A1 Giacalone, J R. System for electronically distributing, displaying and controlling advertising and other communicative media. A system is proposed for scheduling content via network and storing content on server database. Various parameters such as frequency, interval, time of play and events are used with input preferences to plurality of output devices. This proposed system schedules content via client input interface and while connected to a database does not provide any remote or local automatic optimization tools for display nor data mining analysis for optimization system in large retail chains.

KhiMetrix: Price optimization and Dynamic Pricing. One of the retail revenue optimization systems using gross margins and sales optimization to set optimal prices, bundles and position items to achieve net profit increases in retail environment data mining systems. This is a software application and does not directly present any digital promotion system to combine with optimal pricing system.

U.S. Pat. No. 6,138,105 Walker, et al. System and method for dynamic assembly of packages in retail environment.

US 2001/0011818 A1 Dockery et al. System and method for promoting stores and products.

Megaputer: Market Basket Analysis http://www.megaputer.com

Market basket analysis examines list of transactions per shopping cart (market basket) per customer. The goal of the analysis is to determine which of the items sell together at the same time for each purchase basket (or specific person-in the custom targeting promotion embodiment). Depending on the analysis rules (Product Association Rules), the results can be categorized according low-sales or high-sales item groups or the same sales department (see http://www.megaputer.com/tech/wp/mba.php3#multiple)

U.S. Pat. No. 6,205,431 Willemain, et al. Mar. 20, 2001 System and method for forecasting intermittent demand.

A Data Mining Framework for Optimal Product Selection in Retail Supermarket Data: The Generalized PROFSET Model (tom.brijs, bart.goethals, gilbert.swinnen, koen.vanhoof, geert.wets)@luc.ac.be

### Other References

Cleveland, W. S. and Devlin, S. J. (1988) Locally Weighted Regression: An Approach to Regression Analysis by Local Fitting, J. Amer. Stat. Assoc., 83, 596-610.

### BACKGROUND OF THE INVENTION

The value of Point of Purchase (POP) advertising is well known. The main objective of optimal advertising campaign in any retail environment is to communicate most effectively specific product promotion to specific target audience at a specific period of time.

At present there are no tools capable of receiving real time feedback from an advertising campaign and to accurately measure or evaluate the performance of the advertising effort. There are also no tools for dynamically responding to changing values of the sales and profit data. Even if the real time data for customer preferences would be available since the customer has already left the store we can only obtain this information retroactively after the customer has completed his purchases.

Another problem in developing effective media advertising campaigns is directly related to the technology limitations of presently implemented systems. Using currently available methods to manipulate and analyze the huge amounts of data that today are available to decision-makers can typically take days or even weeks to accomplish. Frequently, the various systems in use will provide data that are no longer relevant by the time the data are analyzed.

The problem becomes even more complex when retail chains need to optimize, maintain and supervise mass advertising campaigns that are flexible enough to be centrally controlled and individual enough to serve multiple display nodes in single individual store.

Furthermore, there are, at present, no automatic methods or tools available to the media planners for optimizing advertising campaigns in real time. Many media planners have the data available to make strategic decisions regarding advertising, but the available planning tools do not allow rapid and easy access to the data in real time. Specifically, known systems do not allow rapid week-to-week or day-to-day analysis of the relevant sample and promotion systems that can reliably respond to hour to hour sale profit fluctuations with a specific advertising campaign response.

Finally, many analysis and decision support systems available today are large, expensive computer systems that many smaller companies cannot afford to purchase.

### SUMMARY OF THE INVENTION

The object of the present invention is to achieve maximum profit increases in large retail chain product sales by target advertising of selected number of individual store items with automatic and fully optimized promotion display system.

Central server of OptiRetailChain uses retail chain data mining engine (RDME) and updates large number of local chain store servers in real time and their individually networked PC-equipped Plasma screens and other display modules.

The system selects and optimizes large quantities of electronic digital media clips according to specific association rules based on product market basket analysis, inventory and net profits data as well as other location-specific factors.

The invention eliminates the need for manual input from the chain operator and utilizes real time specific purchase data to optimize customized promotion programs (clip-playlists) for each group of display screen-nodes installed in large number of POP locations in the network simultaneously.

The OptiRetailChain system also generates special dynamic promotion package offers initiated by the chain operator for any specific store location and creates instant promotion package displays automatically based on individual package pricing and validity rules.

All items in the store are first filtered according to revenue and inventory profit margins to obtain short high profit lists of preferred items. Basket analysis is used to obtain individual purchase preferences and is used in a novel way to compute “target” promotion viewing opportunities for every shopping department display. The clip programs for each display node in the store are further customized per hour of the day and subdivided to clip-per minute playing scripts (playlists) according to all available real time and historical local POS (point-of-sale) purchase and market basket data.

The machine-learning components of the system will also allow to simultaneously update optimized playlist programs according to real time data for all local chain store display nodes as well as in the whole retail chain network via secure Internet or Intranet communication system from a central optimization server.

In another embodiment, this invention can be also applied in any networked system, which requires individually customized display programs, messages or E-promotion according to specific customer market data such as is currently available on Web advertising and promotion systems.

### BRIEF DESCRIPTION OF THE DRAWINGS

FIG. 1 Conceptual System Overview of the Present Invention

FIG. 2 Automatic Optimization and Multi-Display Model

FIG. 3 Revenue and Basket Analysis

FIG. 4 Table of Purchase Basket and Department Analysis

FIG. 5 Historical and Association Rules for Products and Display Matching

FIG. 6a Automatic Optimization and Multi-Display Function

FIG. 6b Automatic Optimization and Multi-Display Function-Continued

FIG. 7 Automatic Dynamic Package Pricing Optimization Assembly

FIG. 8 Automatic Dynamic Package Pricing Optimization Assembly-Continued

FIG. 9 Automatic Dynamic Package Pricing Optimization Assembly-Continued

FIG. 10 Promotion-Caused Average Sale Increases: Plausible Ad-Sale Functions

FIG. 11 Relationships Between Clip Presentation, Sales and Sale Profits

FIG. 12 Iterative Optimization Estimation Model

FIG. 13 Modified Optimization Estimation Model

FIG. 14 Client Reports and Control Interface

FIG. 15 Client Input and Constraint Parameters

### DESCRIPTION OF THE INVENTION

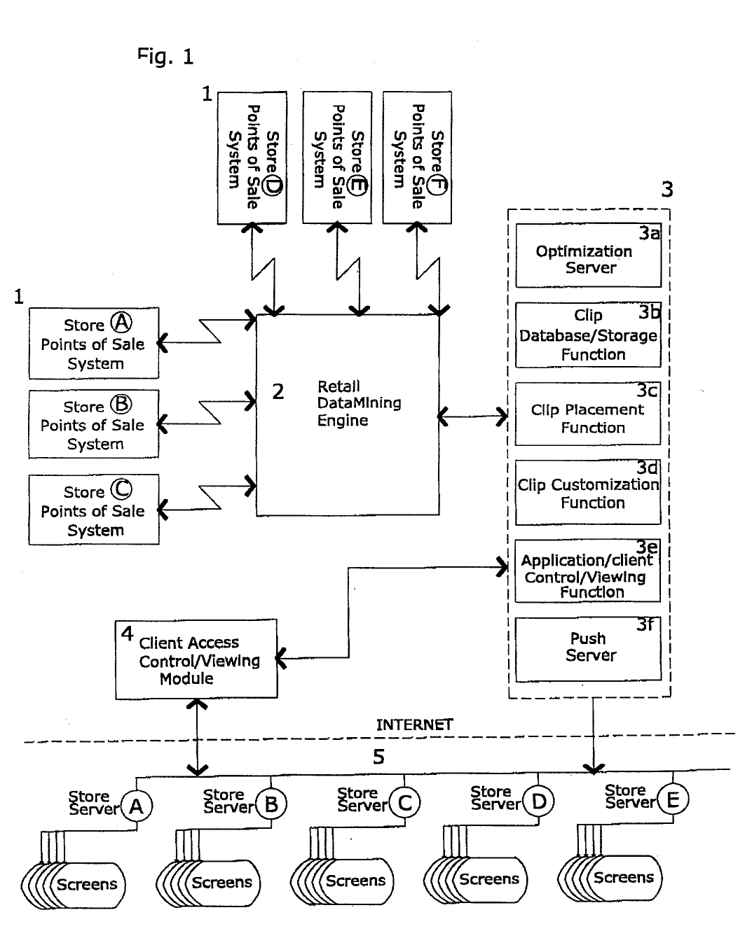

The present invention is an automatic computer-based optimization system that includes five main components (FIG. 1): POS (point of sale) data collection (1), database mining engine (RDME) (2), sales profit optimization apparatus (3), customer access and management control and viewing module (4), and in-store electronic clip display system (5).

The automated retail data-mining engine obtains POS (1) data from all the stores in the management chain. The sale data are stored per store with specific department IDs, date and time of sales and individual purchase basket data.

The OptiRetailChain optimization server (3a) accesses data-mining engine RDME via automatic query/interface, obtains the relevant sales data per each store and determines the optimal display allocation, timing and distribution of all media promotion per each display screen in every store and the entire chain network.

The optimization server also maintains central video clip and media storage database function (3b). All media clips are automatically verified and updated on the central master database.

The master database contains all the available media clips with specific data information including name of clip, clip/product ID, type of clip media, time of media creation, clip duration etc. Each store in the chain is also equipped with a local service server responsible for local media storage and display database.

The local database maintaining clip media storage necessary for daily display program of playlists is updated daily in order to improve performance quality and speed up local real-time display.

The clip placement function (3c) makes automatic clip updates to all store servers and their local clip databases according to daily and hourly timetables from the system-generated display scripts and also updates and maintains local server clip-inventory lists.

The central display server also manages media clip-customization function (3d).

Various video clip package offers are created automatically for dynamic package-price displays according to market analysis results and other factors typically produced by chain store operator profit analysis.

The central display server also contains application and client control viewing function (3e) that enables client access and viewing through client interface module (4).

The Internet/Intranet push function (3f) updates all clip databases for local chain stores and maintains global interface functions such as equipment function tests, display node function status etc.

The customer interface module (4) provides client access and viewing capabilities of the promotion system. This function allows individual custom viewing and management from outside secure-access interface and interactively permits users to view and propose alternate sale strategy goals, promotion effectiveness, and other optimization rules.

The individual store display system (5) typically includes multiple 10 to 20 display screens operating in a secure in-store Intranet environment for displaying digital clip advertisements for each individually scripted playlist. In the preferred embodiment all communication between local server and each individual screen will be performed by wireless communication allowing for maximum flexibility of screen locations and screen-locating optimization.

### Automatic Optimization and Remote Media Display Model

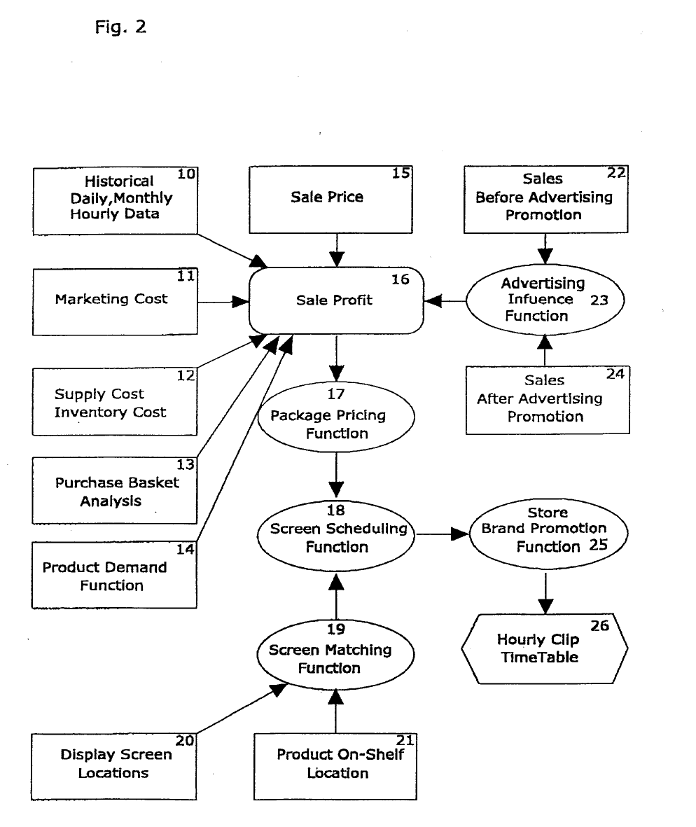

FIG. 2 illustrates the functional relationships of the proposed automatic optimization model. Various input functions which have direct influence on potential levels of the in-store sale profits (16) are used for establishing promotion optimization objectives and rules.

The model uses influence parameters such as historical monthly, daily and hourly sales data (10), marketing costs (11), and supply and inventory costs (12) to compute revenue margins for all products. Purchase basket and department analysis (13), products demand function (14), current sales price (15), and special in-store package pricing function (17) are all applied to achieve promotion optimization goals. The system obtains input from these and other database and data mining functions according to supplied rules and constraints and generates optimization display schedules as will be described later.

Sales advertising influence function (19) is another parameter the optimization system uses to evaluate the impact of the system generated advertising promotion campaigns. It takes into account sales figures for individual products before the item-specific advertising promotion (18) and the resulting product sales after advertising optimization (20). The sales advertising influence function updates data automatically for a specific period of time and is part of the machine-learning components of the present invention.

Product's sale-price data (21) for specific hour (60 minute period) are obtained from real time POS data or corresponding (latest) historical data (10) from all market basket purchases from RDME. Relevant periods are based on previous corresponding monthly, daily and hourly market data analysis. Typically, the period relevant to the optimization computations refers to previous week purchase data, which are correlated by date, hours, minutes and other relevant time such as local specific factors.

Where real time data from wireless on-line POS devices are available on the server, sale profits will be analyzed in real time first as a function of marketing costs, supply and inventory costs and sale price. Special validation rules are applied to verify that enough support and confidence level data exist to enable real time analysis or the results need to be supplemented by additional historical data. The purchase basket analysis (16) provides the main product-purchase and department cross-matching data for a relevant time period to the promotion optimization system.

There are two major embodiments in the present invention.

In the first embodiment, the purchase basket analysis provides the basis for the promotion optimization system. In the second major embodiment, the promotion optimization system relies on statistical estimation of advertising influence curves.

### Revenue and Basket Analysis

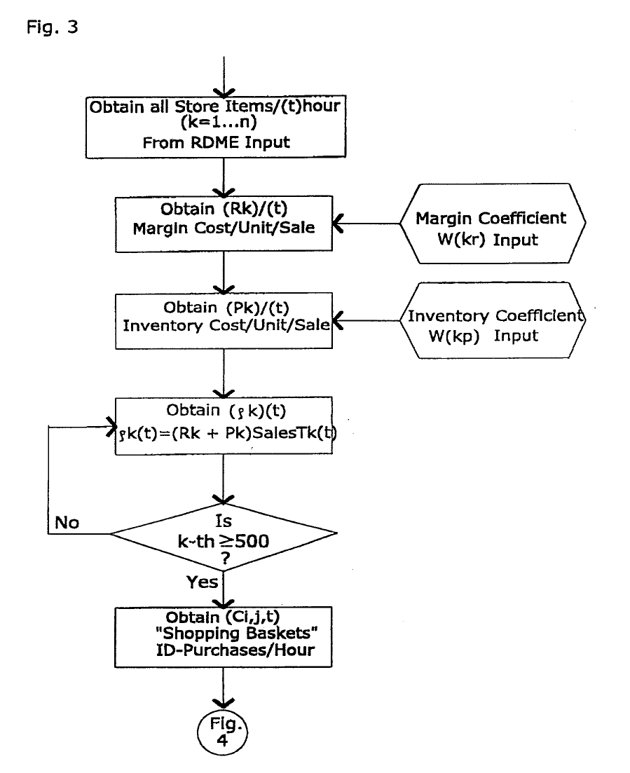

The revenue and basket analysis is performed by the system to obtain all items purchased in specific supermarket for any given period of time T (say identical day previous week) which were stored in the RDME data base, see FIG. 3.

In order to deal effectively with large number of purchases, and to reduce computation time and database processing, the system applies revenue analysis to determine a group of highest profit generating items i.e. item shortlist to be used in automatic clip advertising. Out of thousands of items purchased in each store for given period only a shortlist containing a few hundred items will be selected which currently yield maximum overall profits in the store.

The system obtains a list of all products (say 20,000 items) purchased in the supermarket in the given period and from them selects a shortlist of, say, 500 individual products whose margin profits contribute most significantly to overall store profit gains using two main criteria: sale margin cost Rₖ and product's inventory cost Pₖ, k=1, . . . , K=500.

Product's sales margin costs Rₖ for all items are obtained from the retail chain RDME. Margin cost factors W_{R} are included in the system to enable external modification of margin costs and other inputs by the operator as desired.

Product inventory cost Pₖ is the next factor used in revenue analysis. Constraints such as refrigeration costs and storage costs and handling charges etc. will often become significant factors affecting the inventory costs and supply and demand requirements.

The present invention obtains inventory cost Pₖ for all purchased items. It should be noted that the system enables the client to adjust an external inventory coefficient W_{P} together with the inventory cost Pₖ allowing for manual input according to specific in-store requirements. The coefficient W_{P} can be increased allowing for larger expected future expenses due to expiry dates and other factors. Where necessary the margin cost factor W_{R} may also be adjusted obtaining general weighting coefficient for each shopping item for the period T to enable necessary adjustments of revenue profits by the system automatically:

σₖ=(RₖW_{R}+PₖW_{P})Lₖ

where Rₖ is margin cost of product k,

Pₖ is inventory cost, i.e. price of storing of product k,

Lₖ is total cost of sale transactions of product k.

Now the list of products is sorted by decreasing values of σₖ and the first 500 items are selected for the promotion group. The outside limit of 500 items is entered manually by the client specifications but can be also set automatically for each 60-minute or longer time period. Naturally, this limit can be also adjusted automatically according to specific functional requirements, store display capacity and computation time limitations.

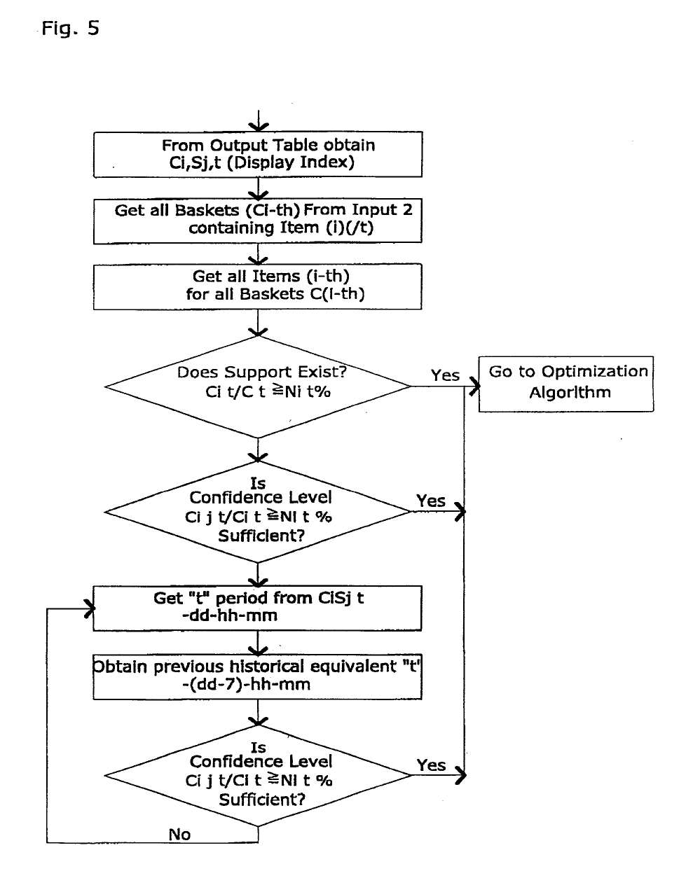

In some instances, it may also be necessary to supplement current period sales data, depending on the current overall store sales Lₖ to obtain minimum support level quantities. The system will then use historical data from previous equivalent time periods in the retail database as will be shown below in FIG. 5.

The optimization system will now use the purchase shopping basket analysis to determine best display screen and product matching for optimal promotion.

### Purchase Baskets and Department Analysis

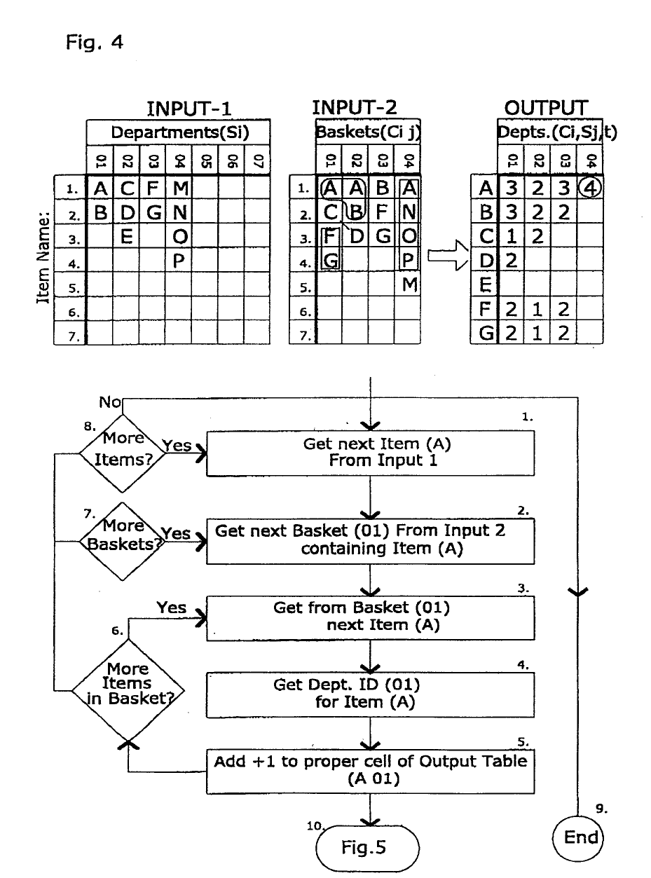

All shopping baskets Cₖ containing item k selected for a given time unit, say, 1 min., are obtained from RDME database. The table INPUT-1 in FIG. 4 contains all selected items stored in specific departments with corresponding display units Sⱼ, j=1, . . . , J. As will be shown later, each product item will be assigned to specific display unit Sⱼ by a special screen-matching algorithm.

In conventional market basket analysis models (such as PROFSET) the product-bundle rules (product associations) are used for direct in-store marketing (i.e. on-shelf) display promotion strategies. In these models the individual purchase baskets are examined for various product-pair associations to develop set of purchasing “bundling” rules and to maximize cross-selling profits.

The object of the present system is to apply screen matching optimization system and identify the best “match” display screen for an item A where it can automatically target promotions to maximum number of customers purchasing item A (i.e. the most potential customers) for that given time period.

The system applies basket purchase analysis to compute “Promotion Display Index” PDI for each display node Sⱼ. The Input-1 Table in FIG. 4 shows selected ‘shortlist’ products and matches each product to a single specific department. The display screens and department cross-matching algorithm described later will assign the individual products and their departments to specific display node. The Input-2 Table shows all purchase-baskets for the current period with all the itemized individual basket products.

The optimization system begins the product and optimal display target matching process for each item and tabulates the results in the item/department Output Table. The system computes the optimal display target node for each item on the basis of maximum “bundle” purchase occurrences of promoted item A with other basket items from the same “parent” department. Display screen is eventually assigned after the optimization system finds the highest PDI rating for each individual item.

The computation process may be described in the form of following flowchart in FIG. 4:

Item A is chosen from a list of all items purchased in the given unit (say, 1 minute) and is obtained from Input-1.

The system also obtains all other shopping items in each shopping basket containing item A for that time unit. The Input-2 table shows Baskets C₀₁, C₀₂ and C₀₄ all containing item A. By analyzing Input-1 Table we obtain the Department S₀₁ as a parent location for items A and B. The system therefore records PDI rating of 3 purchase occurrences for item A in Department S₀₁—one in each purchase basket C₀₁, C₀₂, and C₀₄. Similarly all display locations are rated for bundle purchase occurrences. The Output table shows that the highest PDI rating for item A occurred in department S₀₄ where items M, N, O, P were purchased. All purchase baskets Cₖ for each item k are subsequently evaluated by the number of occurrences of preferred “bundle events” with other items and are recorded in the Output table which is updated dynamically for the given time unit.

We can define the Promotion Display Index PDI for item k in a purchase basket as

$${PD I}_{ik} = {\sum }_{j = 1}^{{C}_{k}} {q}_{jk}^{i}$$

where

Cₖ is total number of baskets containing item k,

qⱼₖⁱ is quantity of items in department i in j th basket from the set of baskets containing item k.

It should be noted that the proposed system relies on real time POS data to obtain recent best-match display screens for each promotion item based on latest purchase baskets data.

### Historical and Association Rules Applied in Products and Display Matching

In absence of sufficient real time data, historical purchase data for similar periods can be obtained from the retail database RDME. The data will be used to update purchase baskets support level applying historical and association rules (FIG. 5). The system searches first the real time support data for all baskets Cₖ containing item k and verifies that a minimum sufficient support level MSₖ exists in all purchased baskets C as set automatically or by client's input for time unit

Cₖ/C≧MSₖ

In the event one of the above conditions is not true, the system accesses historical RDME database to obtain data for the equivalent time period from a previous week (7 days) i.e. (dd-7)-hh-mm or previous data. Once the required threshold has been achieved, the system proceeds to the next stage of optimization process.

Similarly confidence level M is calculated for the real time data to verify if there were sufficient other purchases j with item k in all baskets containing item k to satisfy minimum confidence level in all purchases

Cₖⱼ/Cₖ≧MCₖ

where Cₖⱼ is the number of baskets containing both items k and j,

MCₖ is the minimum confidence level for other items in all baskets Cₖ with item k.

Using historical data, the system updates automatically both support and confidence levels.

In another embodiment of this invention, the real time customer shopping preferences may also be obtained directly from customer on-line purchase history data on the Web.

Other purchase data obtained from on-line sources such as “on-line shopping clubs” or “smart cart” wireless POS shopping devices, where available, may also become source of customer on-line shopping preferences and will be combined with other shopping and demographic data.

### Department and Product Display Matching

In previous discussion it has been assumed that each product is directly matched with the respective department-display node. This may however be misleading, as it may not always be possible to provide display screen for each department category individually. The supermarket chains often have hundreds of categories containing large number of items. When considering target promotion in supermarket environment it is necessary to enable product and display matching in an efficient manner. Some proposed models such as PROFSET use selected products to represent item categories in each itemset and then apply target promotion accordingly.

In the present system we propose automatic screen and category selection. If Sₖ is a display screen for item k, and Dₖ is the department category containing item k, we have the following combinations for screen and department category configurations.

Configuration 1: For every department a separate individual display screen is available

Sₖ [symbol] Dₖ

Configuration 2: Every screen displays products from several departments

Sₖ [symbol] (D₁, D₂, . . . )

Configuration 3: Products from one department are displayed on several screens

(S₁, S₂, . . . ) [symbol] Dⱼ

In the first two configurations, the system automatically selects the appropriate screen, the selection being also updated automatically for each new item as it is entered to the store database. The system obtains item category and proceeds with screen assignment based on in-store location coordinates of display nodes, lines of vision and distances to the items' on-shelf physical locations. Display nodes can also be arranged back-to-back with display screens facing two opposing sides and thereby increasing clip exposure potential. In configuration 3 where several screen options are available for each product, the system randomly selects one of S₁, S₂, etc. During the optimization process, the function will assign automatically random display node to each product separately and update the playlist data accordingly.

### Promotion Optimization Display System

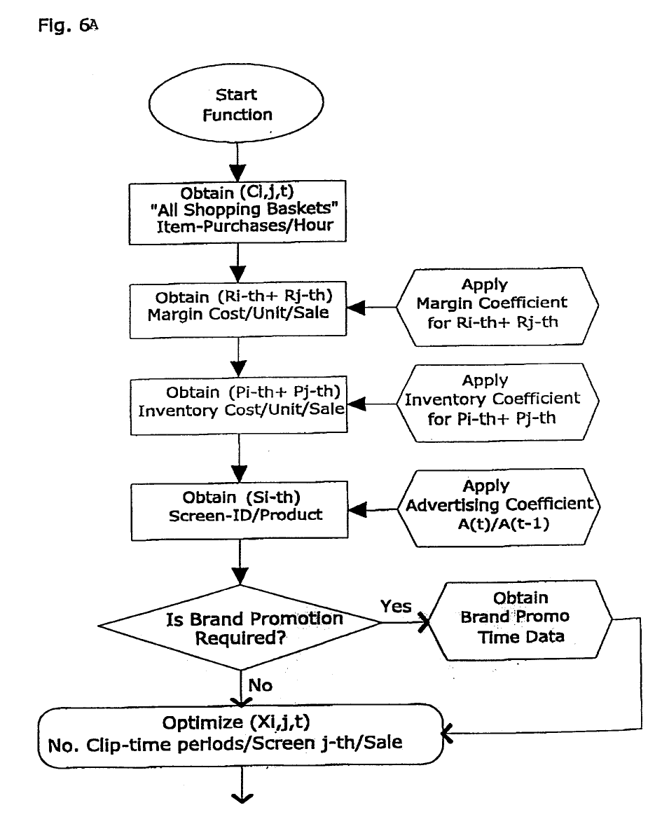

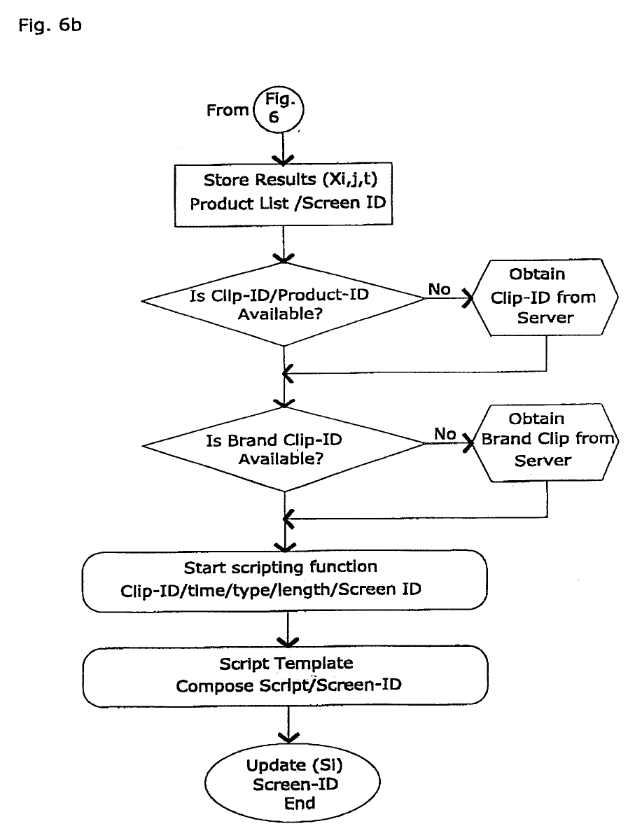

FIG. 6 graphically illustrates automatic optimization display function used for dynamic promotion. As mentioned before, while many stores already use product-bundles rules (rduct associations) successfully in direct marketing (on the shelf display) the present invention applies association rules and functions in basket item-to-display matching algorithm.

After the real time and historical market basket data were analyzed and validated as described in FIG. 4 and FIG. 5, other optimization parameters such as revenue and

inventory costs are now applied to optimize promotion programs for each display location.

The optimization system obtains basket items matched to displays “ratings” from PDI index, see Output Table in FIG. 4. As explained before, the BDI index is maximized when the basket analysis finds high occurrence item purchases (viewing opportunity) for specific item j at a specific display location Sⱼ. Next, the algorithm obtains the product sale margin cost ($) data (Rₖ th and Rⱼ th) i.e. sales profit per each unit pair for each basket purchase. Higher sales margin ratio of each product pair is an important factor in overall profitability calculations as well as optimal screen location.

The product inventory cost Pₖ will also directly affect the display optimization strategy. High inventory cost per item will often indicate incentive for display promotion. In order to allow flexibility into the system, another coefficient Wₚ has been introduced to allow “inventory clearance” promotion strategy i.e. allowing for promotion of high inventory cost items.

In the preferred embodiment, the system objective is to find the optimal display screen-nodes for the maximum number of highest net-profit earning items-advertising clips at a given inventory cost at the optimal display time (in the 60-minute period).

The promotion optimization display algorithm is as follows:

Input:

Pₖ is inventory cost of product k (k=1, . . . , 500),

Cₖⱼₜ is number of baskets containing products k and j together during time unit t,

k, j=1, . . . , K=500, t=1, . . . , T=60 units per hour, where T is number of time units in an optimization period (hour),

Rₖ is margin ($) per unit of product k,

Sₖ is screen number (department/row) assigned to product k,

Aₖ is ratio of sales after current advertising session to sales before the session, the initial value of Aₖ being set equal to one,

Wₚ and W_{R} are inventory and margin weighting coefficients respectively.

Decision variables:

Xₖⱼₜ is time (sec) for advertising product k on j th screen at time unit t.

Maximization is performed over objective function expressing pairs of products best selling strategy

$${\sum }_{ k = 1}^{K} {\sum }_{j = 1}^{K} {\sum }_{t = 1}^{T} {C}_{kjt} {X}_{{kS}_{j} t} [ {W}_{P} ( {P}_{k} + {P}_{j} ) + {W}_{R} ( {R}_{k} + {R}_{j} ) ] ( {A}_{k} + {A}_{j} )$$

subject to constraints

0≦Xₖⱼₜ≦60=3600 sec/60 sec

$${\sum }_{k = 1}^{K} {\sum }_{t = 1}^{T} {X}_{kjt} = {b}_{j} , j = 1 , … , J$$

and

where bⱼ is time limit of j-th screen.

In the Output in FIG. 4, the resulting advertising clip timetable for one-hour period will then be translated into playlist schedule for each individual display and updated on the main server.

### Time Resource and Screen Time Optimization Function

Display screen time optimization function is used in organizing playlist timetable for each time period. While various promotion clips may vary in duration time, in general the optimization system will seek to fill out the hourly program to its maximum (full 3600 seconds). However, in some instances it may be required to “reserve” certain time display slots for “prepaid” promotion clips while the promotion optimization strategy continues uninterrupted. Or it may be desired to repeat certain promotion clip a number of times at the same display location or even at multiple locations.

For example, if some prepaid time block is requested for display of Brand item k, the system optimizes the promotion playlist resulting “net” time without reserved time blocks Qⱼ obtained from external input variable or brand promotion function (BPF).

The system will update optimal screen timetable computations for each 60-Qⱼ minute time slot automatically:

$${\sum }_{k = 1}^{K} {\sum }_{t = 1}^{T} {X}_{kjt} \leq 3600 - {Q}_{j} , j = 1 , … , J$$

where Qⱼ is reserved time block of j th screen.

Another constraint is introduced to maximize clip-revenues from Pre-paid Brand promotion clip displays for the specified period T:

$${\sum }_{t = 1}^{T} {\sum }_{j = 1}^{J} {X}_{kjt} \geq {B}_{k}$$

where Bₖ are the times for display pre-paid clips for the given time period T.

It should be noted that all the above constraints used in the present invention are input parameters to be set by the client management.

### Item Purchase Price Factor

In another variation of the preferred invention, we optimize the price factor PFₖⱼₜ of all basket purchases made in a time unit t. Specifically, we look at all baskets Cₖ containing item k and find departments (categories) where the most valuable purchases (highest portion of total purchase amounts) were made in the store. Assuming that the customers shopping for more expensive category-items k made more intensive shopping decisions and spent longer portion of their purchase time in these specific departments due to product's cost considerations, the system then will direct more item k clip promotions to these departments. We can then compute the price factor as follows

$${PF}_{kjt} = {\sum }_{i}^{} ( {W}_{P} {P}_{i} + {W}_{R} {R}_{i} ) {A}_{i}$$

where the sum is over i in Dⱼ∩Cₖₜ,

Dⱼ is the set of items in j th department,

Cₖₜ is the set of items in all baskets containing item k at time unit t,

Aᵢ is the ratio of sales of item i in the current period to previous period.

Substituting PFₖⱼₜ into the objective function expressing pairs of products best selling strategy we obtain

$${\sum }_{ k = 1}^{M} {\sum }_{j = 1}^{J} {\sum }_{t = 1}^{T} {PF}_{kjt} {X}_{kjt}$$

In the Output in FIG. 4, we obtain the display program where Xₖⱼₜ equals time (sec) for advertising k th product on j th screen at t th time unit. The price factor PF becomes maximized for the appropriate display screen selection while all other parameters remain as discussed before.

### Brand Item Display Function with Net Present Value

In retail environments it is often desirable to pursue multi-faceted promotion strategy. High profit optimization approach will result in promotion of relatively small group of high profit margin products but the resulting playlists may not include many in store Brand-items. The supermarket management may need to advertise Brand-items to increase future profits despite current lower profit values.

The present invention therefore introduces Brand-item Display Function (BDF) for the proposed optimization system, with dynamic “package-pricing” function (PPF) for specific supermarket “Package-Offers” i.e. product bundles promotion strategy. BDF is used in this invention to enable the retailer to achieve optimization benefits for in-store brand items. In the present revenue model, BDF may not qualify due to revenue restrictions for item promotion as set in the optimization group containing, say, top 500 products as described above.

It is obvious that where number of items is limited to optimal set of promotion items and the Brand item k may not qualify among the top items of the promotion group due to lower or negligible profit margins. The system therefore includes additional factors when it is desirable to promote selected Brand item.

To increase the store Brand item profit margin characteristics, the system uses Net Present Value (NPV) function and calculates forecasted profit margins for Brand items for each period. The forecasted future profits for a period of, say, n months are used in current period computations for each brand item and distributed on per month basis to obtain current NPV.

The forecasted profit of a brand item can be obtained from the client's input and is applied to optimization function for that in-store Brand item automatically.

The predicted profit margin of Brand item σₖₙ is calculated for predicted amounts of item sales Lᵢₖ and predicted values Rᵢₖ for n months. Now, assuming distribution period of n months with interest costs x%, the Brand item's NPV will be calculated as

$${σ}_{kn} = {\sum }_{i = 1}^{n} \frac{{R}_{ik} {L}_{ik}}{{( 1 + x \% )}^{\frac{i}{n}}}$$

It is expected that after the selected Brand item NPV adjustment, the its current revenue margin will sufficiently increase and will allow the Brand item to be included in the top 500 promotion items by the automatic promotion system process.

In another variation, the retailer may require custom clip promotion campaign for a number of pre-paid clips “reserved” for a given hour at any number of display nodes. The system will then use the Time Resource and Screen Time Optimization Function described above using “reserved time”, i.e. clip display time as constraint in the screen optimization model without computing the revenue margin values.

In this variation, the reserved clips IDs are included in the custom Item Promotion Table with the pre-set preferred display time reservations and are automatically featured in the current playlists and displayed at an appropriate screen display nodes.

### Brand Items Playlists Creation and Playlist “Time-Slot” Reservation

The timing requirement for Brand item reserved clips for preferred promotion items are now entered into the hourly playlists calculations. Reserved “time-slot” data for each in-store Brand item are pre-set by the system or by the control management and are entered into proposed promotion playlists where the brand items are treated as separate “new products” (i.e. without current profit margin values).

Similarly where the purchase bundles promotion clip-items are required and need to be included in the display playlists, a separate clip assembly function described below will be used to fill the reserved slots made available by the “reserved time-slot” optimization program. The Brand item promotion can also be set externally by the client with remote input permission as will be described later whereby the optimization system “blocks” specific time-slots in each playlist for client-targeted Brand item promotion.

### Dynamic Package Pricing Function

The package-pricing function (PPF) is introduced to enable the optimization system to select automatically in-store package-offers promotions, which are generally offered by the chain-store management. However, this function must be also fully compatible with the proposed promotion system. The main purpose of this function is therefore threefold:

To automatically access and identify store-offered Package Offer deals;

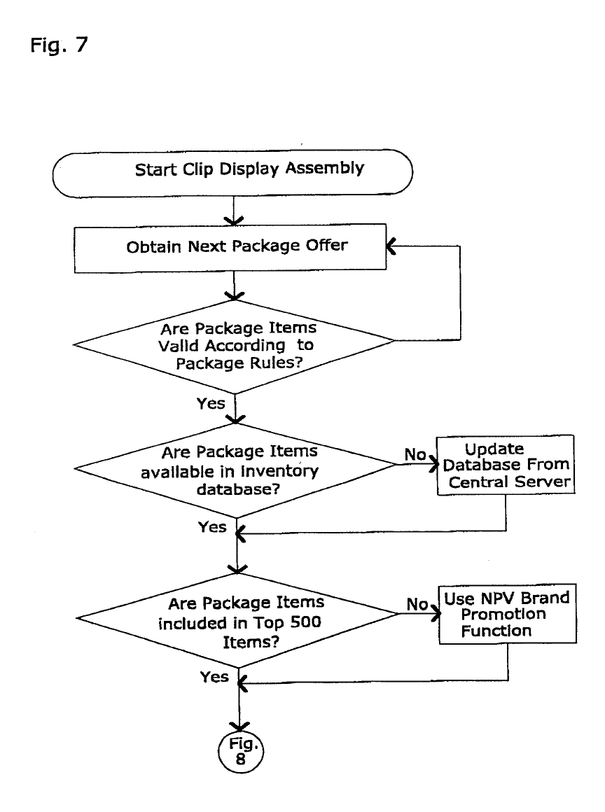

To automatically assemble media clip display packages consisting of two or more items as offered by store and to dynamically compute Package Offer price offers according to pre-determined validation rules. (See FIG.7);

To incorporate dynamic Package Offer pricing assembly with automatic optimization computation and screen display matching without external input.

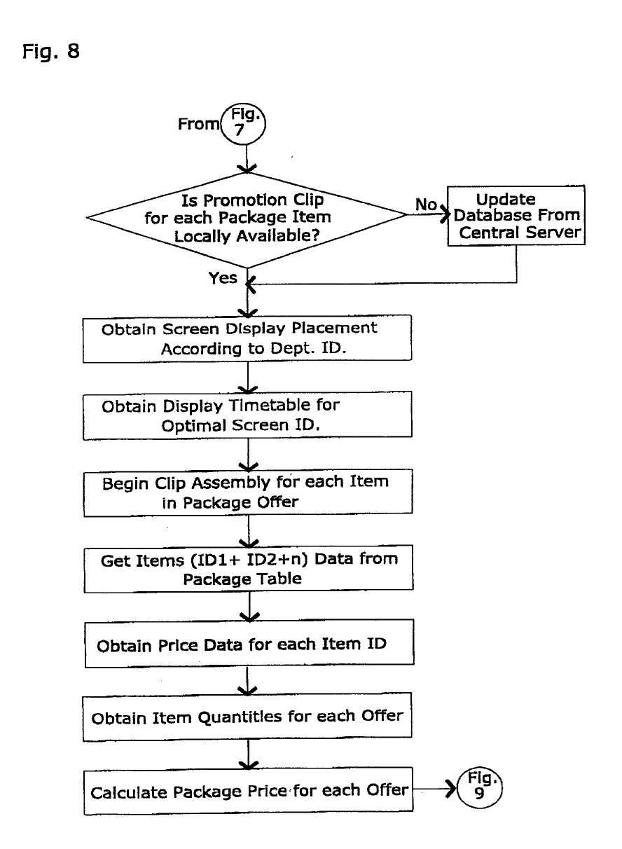

The automatic clip assembly begins after the system searches in-store Package-Offer Table and identifies current Package Offer deals (FIGS. 7-8).

Two possible input options in Package-Offer table are available:

a) Supermarket chain determines automatically the promotion bundle prices;

b) System utilizes the purchase basket data to promote automatically package bundle combinations and uses the highest cross-selling profit margin to set the cost for package bundle offers (see future embodiments).

In this embodiment, we will discuss only option a): the system verifies Package ID, Package item components, proposed item quantities, package pricing and corresponding clip IDs in the Package-Offer Table. Clip assembly process is initiated after the price and quantities for each item ID in the Package Offer have also been validated in the inventory database, and the items and their relevant clips are available for display.

The current Package Offer validity status is verified by the system in real time. Often the package value parameters may change rapidly within short period of time due to promotion campaign or other factors. Similarly, some items may not be available in the current inventory storage and consequently will invalidate the package offer status.

In the next stage of the clip assembly process, it is essential to compute the current revenue profit margin of the proposed package offer. In the event that the profit of the offer fall bellow the top 500-item promotion group, it will be necessary to perform the net present value NPV predicted adjustment computation for that package. Similarly, it may be desirable to present the package offer as a separate “new” item or Brand item offer as explained above.

The Automatic Package Offer now proceeds with the package clip-assembly.

It should be noted here that in this embodiment the automatic package promotions consist of multiple assemblies with single still-image displays of each package item used as a part of package offer assembly. This will reduce loading and storage requirements and the size of supermarket database as well as rapid processing time.

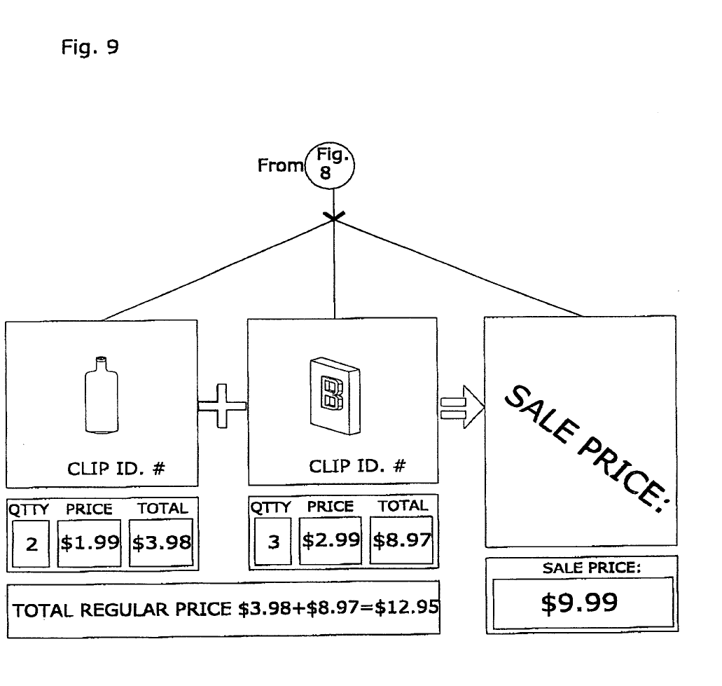

The typical dynamic package consists of 2 to 3 items as shown in FIG. 9. Total regular price is displayed together with each existing Item Price individually. Proposed package Total Purchase Price is displayed automatically together with each item-clip and Final Package price. The optimization system incorporates the selected clip Package-Offer into regular playlist clip-timetable. Using the standard optimization function the system chooses the best display node automatically.

### Advertising Influence Function and Promotion Effectiveness Estimation

Promotion effectiveness measurements are important elements of the self-learning aspect of the present invention. As the display node playlists are automatically optimized on hourly and minute-by-minute basis in real time it is possible to collect enough data for promotion evaluation.

The proposed system uses several approaches to compute effectiveness of electronic promotion on a short and long-term basis and its impact on overall in-store profit figures in the retail chain.

The short-term advertising coefficient A_{kT} for item k is a ratio of sales in the current advertising session to the sales from the session before. Initial value of A_{kT} is set equal to one and is modified automatically according to product sale performance. The same calculation is made for all other items in all purchase baskets:

$${A}_{kT} = \frac{{L}_{kT}}{{L}_{k , T - 1}}$$

where L_{kT} are sale transactions for item k after advertising period, and L_{k,T-1} before advertising period.

Depending on the store product sale results, the advertising coefficient Aₖ is dynamically modified for all new data. When the promoted items increase in sales, the optimization system uses higher coefficient Aₖ to update current display optimization and updates the last playlist.

It should be noted that the advertising coefficient Aₖ is based on data immediately preceding the current display session and not historical data for similar time periods on weekly or monthly basis. It is assumed here that the real data is sufficiently representative of the current promotion trend in the store.

In the second major embodiment of this patent, the effectiveness of clip promotion schedules will be measured by statistically estimating promotion influence curves that show sales increases resulting from particular advertising strategies. This influence curve estimation allows the use of linear optimization tools for modifying advertising schedules in most promising directions.

Longer-range statistical analysis may also be used to study the impact of specific promotion strategy on a group of products using a number of similar stores.

### Promotion Influence Curves

Assuming that targeted clip presentations tend to increase sales (to various degrees), it is desired to develop performance evaluation system that can estimate advertising effectiveness of clip presentations in retail stores and that will maximize overall sales of all advertised products over a longer period of time.

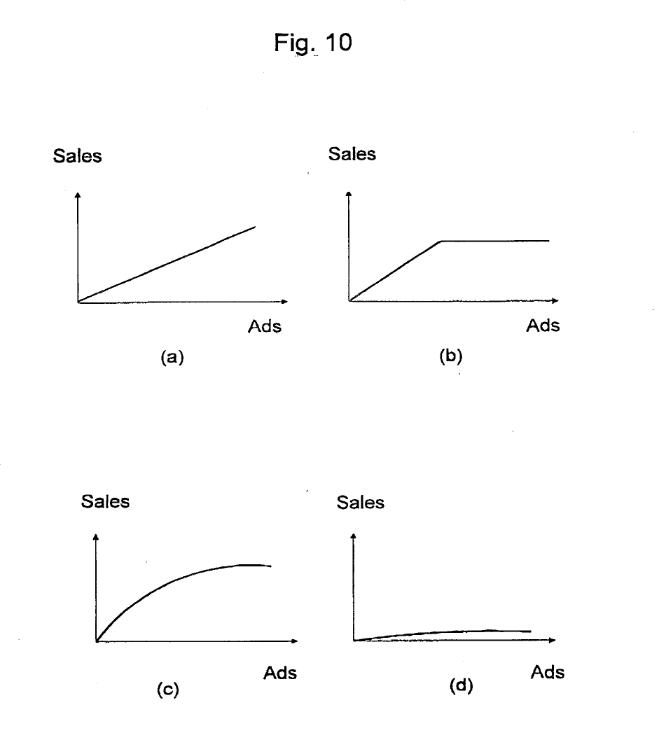

In this embodiment we present statistical model for expressing sales increases resulting from increased numbers of targeted clips and means of assessing them in quantitative terms. Assuming that average sales of a particular product go up for some time with first appearance of corresponding clips, then the increase slows down and eventually level off completely after reaching a saturation stage. FIG. 10 shows four plausible curves of average sales performances of individual items as functions of increases in corresponding clip demonstrations on separate display screens. We will call these functions Ad-Buy curves as they relate ads to buys. The curve in FIG. 10(a) is linear, which is simple but unrealistic as no saturation stage is ever reached. FIG. 10(b) shows initial linear relationship that reaches saturation stage while FIG. 10(c) is a more realistic smooth curve with saturation. FIG. 10(d) shows a situation when sales are not affected by clip demonstrations.

### Optimization Algorithm and Statistical Estimation of Promotion (Ad-Buy) Curves

Assuming that in a given time period, a quantity Yₖ of product k is sold at a profit margin cₖ=RₖW_{R}+PₖW_{R}, the overall profit from all sales of products in question is a sum

G=c₁y₁+c₂y₂+ . . . +c_{K}y_{K} (1)

Although G looks like a linear objective function, the variables Yₖ are not control variables since they are unknown. However, we can assume that they can be written as

yₖⱼ=fₖⱼ(Xₖⱼ) (2)

where Xₖⱼ is the number of clips for product k demonstrated on screen j within a given time period, yₖⱼ is the sales volume of product k that resulted from clips shown on screen j, and fₖⱼ(.) is the corresponding Ad-Buy curve of the kind shown in FIG. 10. Then the cumulative sales of product k can be expressed as

$${y}_{k} = {\sum }_{j = 1}^{J} {y}_{kj} \qquad ( 3 )$$

where j runs over the set of screens. Substituting (2) into (3) and (1) gives

$$G = {\sum }_{k} {\sum }_{j} {c}_{k} {f}_{k j} ( {X}_{k j} ) \qquad ( 4 )$$

Provided fₖⱼ are known and tractable, the overall profit G could be maximized by finding appropriate Xₖⱼ.

Of course, optimization of profit in (4) should be performed under appropriate restrictions. Firstly, the numbers of demonstrated clips are always nonnegative:

Xₖⱼ≧0 for all k=1,2, . . . , K and j=1,2, . . . , J (5)

Secondly, we have restrictions on the numbers of each clip paid for by producers

$${\sum }_{j} {X}_{k j} \geq {B}_{k} for all k = 1 , 2 , … , K \qquad ( 6 )$$

and thirdly, on the numbers of possible demonstrations of all clips on each monitor

$${\sum }_{j} {X}_{k j} \geq {b}_{k} for all k = 1 , 2 , … , J \qquad ( 7 )$$

The functions fₖⱼ in the profit formula (4) can be estimated using an appropriate statistical model and historical records on sales stored in the database. After that has been done, the obtained estimators \hat{f}ₖⱼ can be substituted for functions fₖⱼ into (4) and will give us an objective function

$$\hat{G} = {\sum }_{k} {\sum }_{j} {c}_{k} {\hat{f}}_{k j} ( {X}_{k j} ) \qquad ( 8 )$$

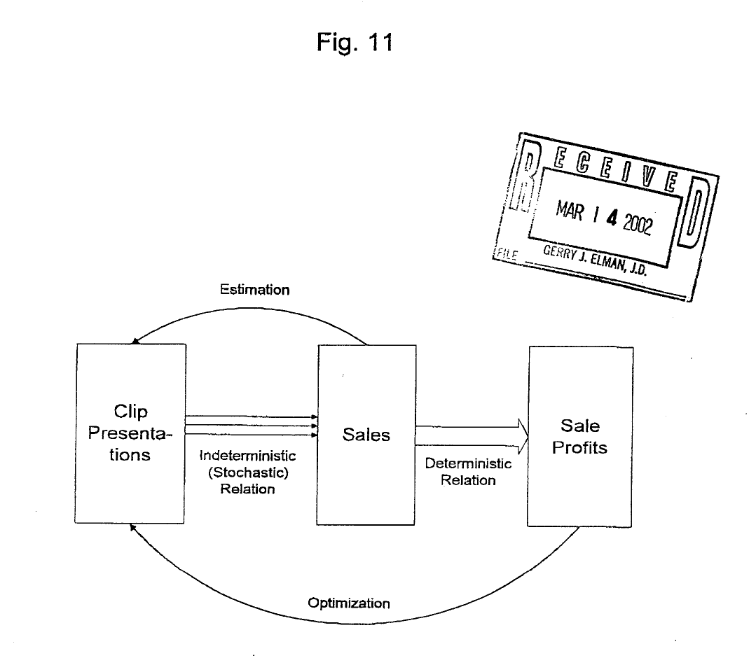

Now we can maximize the expression (8) under the constraints (5)-(7) by mathematical programming techniques. These relationships are depicted graphically in FIG. 11.

### Optimization-Estimation Iterative Setup

The two-way relationships between estimation and optimization implied by the developed model (see FIG. 11) necessitate an iterative mode of operation. An iterative real time estimation-optimization loop is also warranted in view of the following facts:

The dependence of sales on clips (Ad-Buy curves) may be wildly nonlinear, which compels us to prefer to perform ‘slow’ stepwise local optimization.

Random fluctuations in sales and fluctuations caused by unknown unpredictable factors will call for utmost caution in changing existing ‘good’ schedules; we expect a steady iterative process to be self-correcting.

Gradual changes in Ad-Buy curves that may happen over larger time spans can be easily accommodated by a real time iterative system.

For implementing iterative setup, it will be helpful to put a discrete time grid on functioning of the supermarket. It will allow us to arrange calculations for updating and iterative improvement of the obtained optimal solutions into a sequential stepwise process in which estimation and optimization components are two parts of the major iteration step. Since Ad-Buy curves may be time sensitive, e. g. vary considerably from hour to hour and possible among weekdays, it may be useful to structure time grid accordingly. For instance, we can view week as a recurrent time unit consisting of different weekdays. Furthermore, we may divide a working day into, say, four supposedly homogeneous time blocks: from opening to 10 a.m., from 10 a.m. to 4 p.m., from 4 p.m. to 7 p.m., and from 7 p.m. to the closing. Assuming a 6 working day week, we will have 24 homogenous time blocks, which imply that all calculations will be performed in parallel for 24 series of homogeneous time blocks.

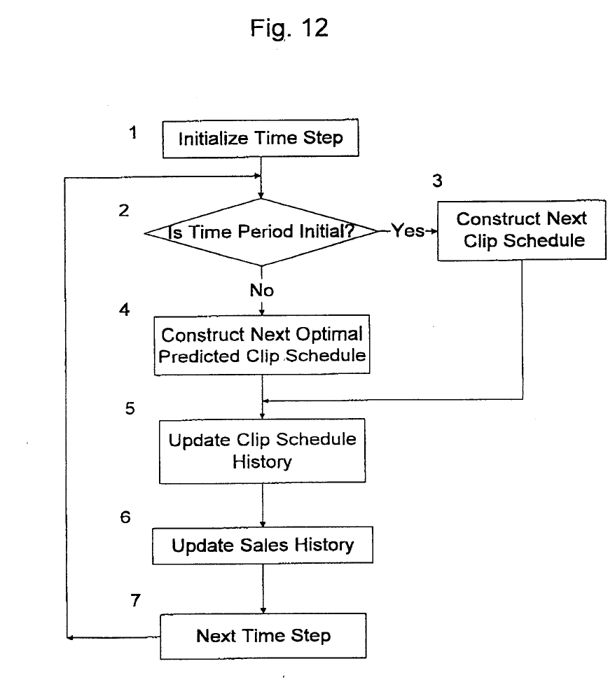

The overall real time iterative process is shown as flow-chart in FIG. 12.

There are two different time periods: the initial period when we do not have enough observations for estimation, and the main period. At the initial period, clip schedules should somehow to be determined, for example, using some ‘conventional’ scheduling method. After the system has run out of the initial period and sufficient data on clip schedules and sales have been accumulated, the main optimization-based period begins.

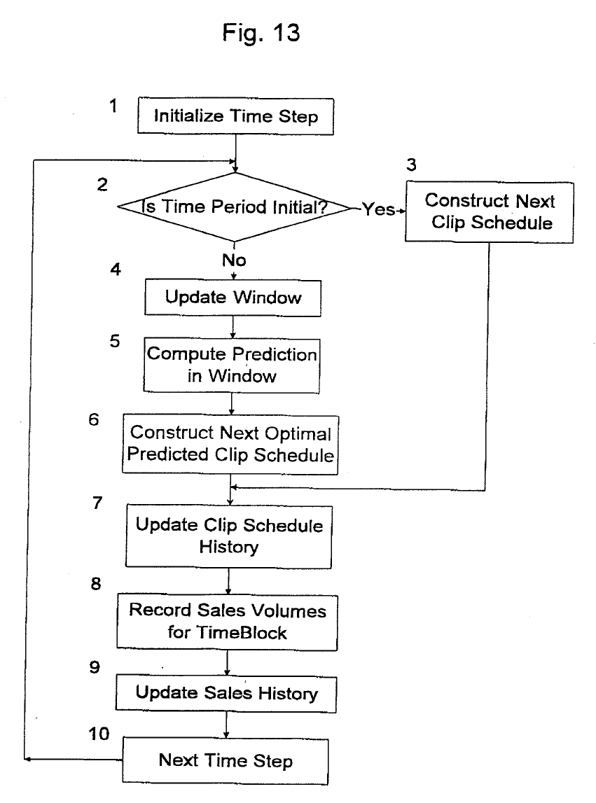

Flow-chart in FIG. 13

If the current period is the initial period (2), the next clip schedule is constructed in (3) based on some a priori rules. If the current period is the main period (2) which means that enough data are available, the computations related to the non-parametric regression-based estimation are performed in (4) and (5). The next optimal clip schedule is calculated by solving the optimization program in (6). In (7) to (9), the records are updated in the database, and in (10) the next time step is initiated.

### Statistical Estimation Model: Locally-Weighted Straight-Line Smoother

If the dependence of the sales means on clip presentations is linear or almost linear like that in FIG. 10(a), the linear regression may be used for fitting the sales.

For highly nonlinear curves like those in FIG. 10(b) and FIG. 10(c), the linear regression will not work well. To remedy the situation we use of a scatterplot smoother that allows the data to select the appropriate functional form. A standard recommendation for such nonlinear problems is to use locally weighted regression like the locally weighted smoother of Cleveland presented in Cleveland and Devlin (1988).

Being locally linear, this estimator allows to use linear programming optimization at each step, however, being on the whole nonlinear, it is capable of capturing the trend of the curves like those shown in FIG. 10(b) and FIG. 10(c). At each step, we fit weighed linear regression equations

Yₖ=1βₖ₀+Xₖβₖ+εₖ (9)

in the selected neighborhood (or window) that provide us with linear predictors

$${\hat{y}}_{k} = {\hat{β}}_{k 0} + \sum {\hat{β}}_{k j} {X}_{k j} \qquad ( 10 )$$

that after substituting into equation (8) gives us a linear approximation to the objective function

$${\hat{G}}_{1} = {\sum }_{k} {\sum }_{j} {c}_{k} {\hat{β}}_{k j} {X}_{k j} \qquad ( 11 )$$

We are now having a linear program of optimizing (11) under the constraints (5)-(7).

At the next step of the time loop, the process is repeated by constructing a new neighborhood around this optimal schedule that will serve as the new current schedule, etc.

### Supply and Demand Function and Promotion Optimization

The main purpose of this function is to apply the results of revenue growth in response to digital targeted promotion to supply and demand prediction values. The system uses supply and demand function with the promotion optimization as a prediction tool for forecasting the product supply and demand requirements based on promotional sales and their impact on purchase trends of the past week, month or year. Demand forecasts are used to achieve high precision short-term (1-week) or longer-term results.

Since it is generally accepted that product sale trends in typical retail environment can be very short it is important to develop high level of accuracy for a very short demand cycle. (See KhiMetrix: Price optimization and Dynamic Pricing)

The forecasted product demand and cost data for short and medium-cycle periods can also be used here to compute longer-term projected product sales and net profit calculations. The product demand projections will be used as basis for comparisons of projected revenue margins with standard in-store promotion and the proposed targeted digital display promotion.

The supply and demand forecasting data will then be used together with the statistical promotion influence-curves from advertising impact calculations and combined together to compute updated supply and demand forecasting values.

In the future embodiment the supply and demand forecasted values will be used to calculate product-profit margins and inventory costs as a function of predicted promotion influence data to be applied in promotion influence studies where alternative clip targets, timetable variations, clip duration and content impacts can be studied.

### Client Reports and Management Control Function

Real time customer viewing and remote access control is enabled with Client Reports and Management function.

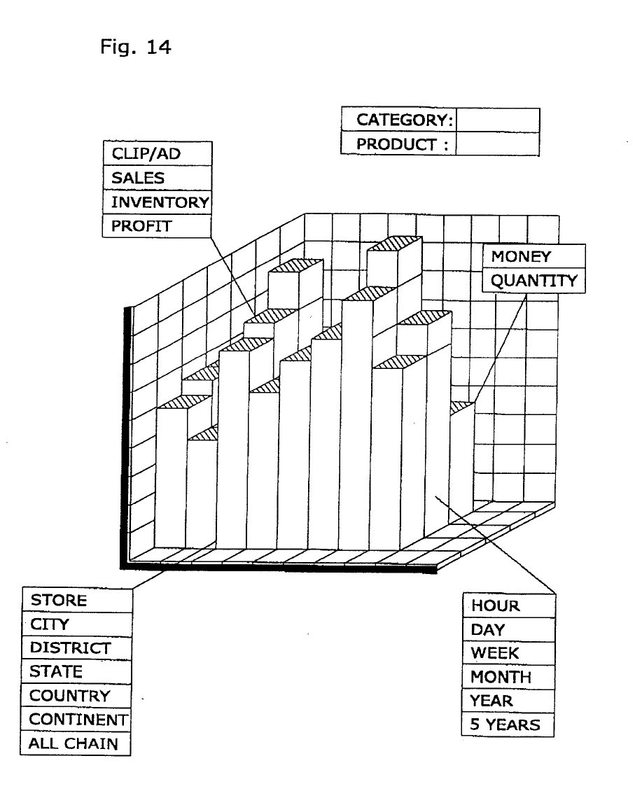

Both clients and retail control management can obtain detailed reports and share information via multi-dimensional and sorting interface shown in FIG. 14. The data presentation is inter-active and allows review of clip playlists, optimization promotion strategy, individual and group items sales profit and inventory data according to various products, their categories, location, time and other parameters.

Individual product categories, profit revenues and stock inventory reports can be viewed as a function of number of clips displayed over a preferred period of time.

Client interface is OLAP enabled via secure on-line Internet or intra-network system and allows viewing and management of the database from remote source as well as full interface to the clip database, clip timetables and display history and all cost analysis data.

Client reviews can be categorized according to individual stores, their particular neighborhoods, city or country in the overall retail chain.

In another embodiment various input parameters are modified both on individual item or product group basis to control display optimization function. It will also include forecasting and simulation algorithms to enable impact studies of item-specific clip promotions and the product inventory requirements.

### Client Input and Constraint Parameters

The proposed system enables individual client manual input function including control of various Brand promotion factors and adjusting automatically each individual display node optimized display time-schedule.

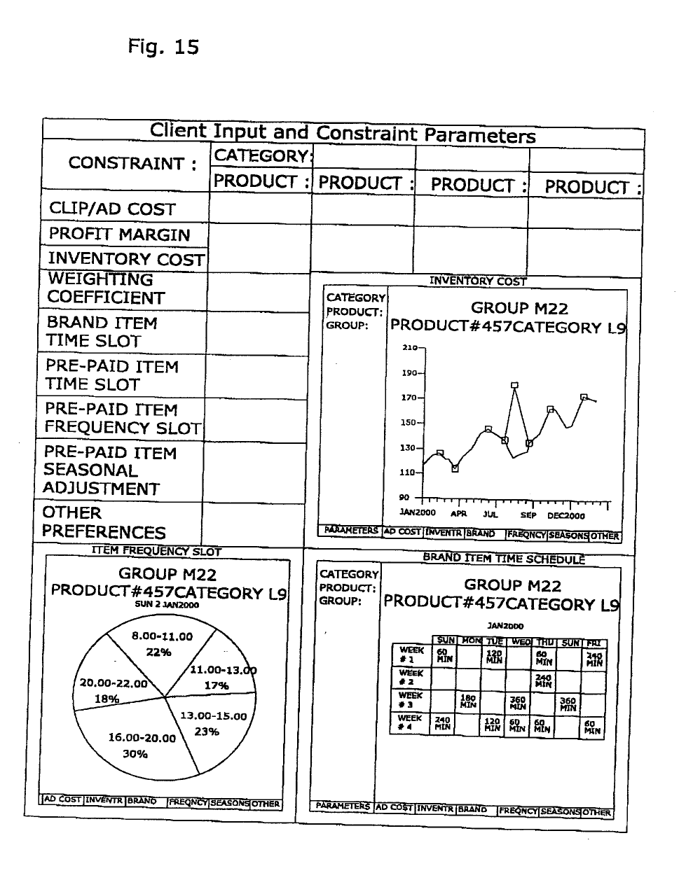

The proposed system enables individual client control input both on individual and item group basis (FIG. 15). The optimization system verifies selected Brand promotion factors and adjusts automatically the optimized display time-schedule.

The control manager or system client user can adjust the selected parameters via interactive dialogues and include individual clip and advertising cost and see its impact on overall revenue profits.

Brand item current profit margins can be modified via net present value (NPV) adjusted profit values input. The client can also specify Brand item preferred time schedule specifying preferred dates and hours as well as the preferred item's daily clip-promotion frequency and distribution. These specifications can be set as the automatic default-state. All these factors are verified according to validity rules and each item parameter can be updated dynamically via on-line visual screens or directly in the client-access-database input.

### Clip Data Base and in-Store Ad System Updating

Centrally located clip server and database are responsible for maintaining and updating automatic clip storage and all promotion data. Generally this data content is in form of digital multimedia video file-clips made for various items and categories both for in-store and other type of promotion material-including brand item clips and package offer promotion clips. The clip control manager verifies the function status of all local controller servers and their current local clip storage database and updates necessary clips according to the latest playlist clip-item requirements. Local controllers updates can be via standard online download function or via daily maintenance update check.

The automatic clip update function can also modify the display node current playlist for each specific store and execute playlist changes for the specific period in the store. Each display node is optimized in real time for each hour and relevant clips are updated according to the last optimization parameters. The clip server searches the local controller server (in-store) database for necessary clip playlist data and replaces new updates in the clip storage database where necessary via push server. All relevant information data such as clip name and ID, length and duration time are used with each playlist and are adjusted to the optimal display node specific location characteristics using previous display data to create an updated playlist.

### Automatic Scripting Function

A standard scripting function in the Central server can be used to combine the clip-data together with display node IP/Intra or Internet location address data and to create specific screen display playlist. All scripting files such as Asp/Txt files can be edited standard editor software and are compatible with Generic Media Player clip-script assembly and display.

It will be assumed that all display nodes will have full 1-hour or 1-day playlist capabilities with specific timetables prepared automatically ahead of display period and valid specifically for each location for each time period. All individual playlists can be updated also via intranet secure communication network. The system will automatically update any local server-display controller and upload all digital data contents necessary for playlist execution.

### Screen Scheduling Function

Clip scheduling function is responsible for clip-playlist output at each screen display ID node for a given time period based on market basket analysis and promotion screen time optimization. Each display screen is associated with a specific product-clip playlist and is optimized for selected viewing promotion content at that particular location.

This function determines automatic clip schedule for each screen display per 60-minute period and also allots fixed time slots for store brand clip promotions. Package bundles displays are also automatically verified and updated on each screen. If applicable it also verifies the validity of Screen Display Rules at each location. The current status of each screen can be monitored and reported to customers online or via secure Internet browser.

### Conclusions and Future Embodiments

It should be noted that two major embodiments in the present invention implement two different approaches to maximization of revenues by effective advertising promotion in retail environment.

The real time short-term approach utilizes revenue management data and basket analysis for display optimization for the current period.

The longer-term statistical optimization model, based on data from last several weeks, analyzes the statistical revenue margin data with respect to specific in-store displays and target promotions. One of the advantages of the statistical optimization system is that it does not depend on any predetermined relationships such as basket analysis or customer shopping preference patterns. Instead, it uses statistical means to evaluate specific digital display schedules in their physical screen locations and directly evaluates their influence on overall store revenues and individual item revenues over a longer-term revenue period.

In the future embodiments, both the real time and statistical optimization system can create time and revenue relationships curves, which will best represent both short-term, and the longer-term item profits with overall chain store revenue gains. The main purpose of this function will be to evaluate long-term influence of targeted digital promotion, both for individual items and overall store revenues separately.

The system can be also used to evaluate promotion saturation fall-off point and advertising promotion content studies. All individual parameters and index values used in the optimization algorithms will be dynamically assessed and updated where necessary in accordance with statistical results. The machine-learning component of the system can automatically increase or limit the overall number of clips for individual item for optimal revenues as set by constraint rules and evaluate hourly screen programs with respect to their item display distribution (i.e. control number of clips per item per hour). The clip display frequency and display order on each individual display and their impact on the overall store revenue will also be studied.

Additional weighting constraints may further be included to develop statistical variance charts for individual screens with preference ratings for each display node for next-best item presentation and its closest display location.

Further studies may also reveal long-term customer time-related shopping patterns and promotion efficiency. The system will also analyze historical activity for any market segment and its response to digital targeted promotion timetable. These can then be applied as separate factors related to individual items and customer purchase time period preferences. The findings can then be incorporated into optimization algorithms.

1. A system comprising an optimization server, a memory coupled to the CPU, an automatic electronic advertising optimization system executed by the server, self-learning advertising optimization system dynamically updating multitude of clip media playlists (display-schedules) to achieve an optimal advertising timetable in a large retail network requiring no additional input.

2. The system of claim 1 further comprising a graphical interface with a plurality of video-clips, catalogued according to subject and other statistics which provide basis for applying rules for advertising optimization system stored in the CPU server storage system.

3. The system of claim 1 further comprising at least one playlist for each remote display station in the retail network residing in the memory of the CPU and controlled by the central advertising optimization mechanism for modifying the base advertising schedule.

4. The system of claim 3 wherein each display station is associated with a list of products dynamically updated for each display node.

5. The system of claim 1 further comprising a database-mining engine residing in the memory of the CPU.

6. The system of claim 5 wherein the database-mining engine further comprises a plurality of Boolean filters used to search the plurality product sales records for each department contained in the database.

7. The system of claim 1 further comprising a data communicating mechanism capable of transmitting product data associated with each display station, associated product categories relevant to that station together with the store identification number and other relevant time and sales data and playlist status to the main optimization server.

8. The system of claim 5 wherein the database-mining engine filters the sales occurrence statistics for various product mixes listing the highest occurrence rating sequence for each display screen location.

9. The system of claim 5 wherein the database-mining engine filters the clip display history statistics for various product mixes.

10. The system of claim 5 wherein the database-mining engine filters historical sales data for various display stations according to date/time factors, with relevant promotion playlist data and relevant store data.

11. The system of claim 5 wherein the database-mining engine filters historical sales data for various display stations according to days, weeks and months according to sales and promotion playlist data for each store location.

12. The system of claim 1 wherein the optimization system automatically searches for best product pairing combinations based on the pair-items sales occurrence and based on the relevant time period for each display station in multiple store locations.

13. The system of claim 1 wherein the optimization system automatically searches possible display location for optimized promotion-bundle display based on relevant sales performance rules.

14. The system of claim 1 wherein the optimization system creates optimal timing sequence based on the clip availability and effectiveness (sales occurrence) for each display station.

15. The system of claim 1 wherein the optimization system creates optimal timing sequence based on custom pre-paid clip-blocks displays.

16. The system of claim 1 wherein the optimization system creates dynamic package-pricing advertising clips based on the promotion strategy requirements for each display station.

17. The system of claim 1 wherein the optimization system creates custom display clip-timetable combined with the optimized promotion strategy requirements for each display period.

18. A method for updating the product Supply and Demand requirements forecasts based on statistical promotion influence-curves from clip promotion impact calculations.

19. Communication network connecting multiple retail nodes of claim 1 in the retail chain to the main CPU server automatically controlling and updating large clip playlist-files for dynamic clip display optimization within the retail chain.

20. The system of claim 1 wherein the optimization system searches and updates available clip storage dynamically for each of the multiple store node servers based on the suggested promotion clip sequence to enable continuous playlist display.

21. Intranet secure network communication system in all store locations connecting display node servers of claim 1 with each individual display node controlled remotely from central server.

22. Networked store display units of claim 1 comprising LCD single or doubled display units and a CPU unit capable of updating video display list and media video player rapidly displaying video clip sequences according the optimization script.

23. A system for applying Department and Product Display Matching where several display options are available.

24. Using basket cost factor parameter for “best matching” screen and item promotion optimization.

25. A system for estimating clip promotion display influence curves by an estimation algorithm.

26. The system of claim 25 further comprising locally-weighted straight-line smoothers capable of dealing with relatively small samples of noisy data.

27. The system of claim 25 further comprising locally linear prediction function suitable for iterative linear optimization.

28. The system of claim 25 further comprising real time iterative optimization algorithm for calculation of optimal clip schedules.

29. The system of claim 25 further comprising method of incorporating constraints such as number of brand item clips and number of clips for given period at each display into the optimization program.

30. The system of claim 25 further comprising client manual input system including various Brand item promotion factors and adjusting automatically each individual display node's playlist time-table.
